(19) United States
(12) Patent Application Publication
(10) Pub. No.: US 2023/0218107 A1
(43) Pub. Date: Jul. 13, 2023

(54) COFFEE MACHINE

(71) Applicant: Zhongshanshi Keliko Technology Co., Ltd., Zhongshan City, Guangdong (CN)

(72) Inventors: Quncai YI, Zhongshan City, Guangdong (CN); Jinyong DAI, Zhongshan City, Guangdong (CN)

(73) Assignee: Zhongshanshi Keliko Technology Co., Ltd., Zhongshan City, Guangdong (CN)

(21) Appl. No.: 17/773,175

(22) PCT Filed: Dec. 13, 2019
(86) PCT No.: PCT/CN2019/125130

§ 371 Date: Apr. 29, 2022

(30) Foreign Application Priority Data
Nov. 8, 2019 (CN) 201911086278.4

(51) Int. Cl. A47J 31/44; A47J 31/46

(52) U.S. Cl. CPC A47J 31/4407; A47J 31/46

(57) ABSTRACT

A coffee machine includes a housing having a first mounting cavity with a first opening opened or closed by a detachable cover plate, a support having a second mounting cavity with a second opening and detachably mounted in the first mounting cavity, a body detachably mounted in the second mounting cavity, and having a brewing cavity with a water inlet and a water outlet at two ends and a feeding port for coffee powder at a side portion, a first sealing plate movably mounted in the body and capable of opening and closing the water inlet, and a first power source mounted on the support and driving the first sealing plate to act, and a water-outlet sealing plate assembly mounted on the support, with an output end slidable in the brewing cavity and a water outlet channel.

### TECHNICAL FIELD

The disclosure relates to the technical field of coffee machines, and more particularly, to a coffee machine.

### BACKGROUND

Coffee machine is a device integrating powder grinding, pressing, loading, brewing and residue removing, which can realize the automatic control of the whole process of brewing coffee. The existing coffee machine generally has a complicated structure, which is inconvenient to assemble and has low production efficiency. To this end, the disclosure provides a coffee machine with a simple structure.

### SUMMARY

An object of the disclosure is to solve at least one of the technical problems in the existing technology, and to provide a coffee machine, which can simplify the structure of the existing coffee machine.

According to one aspect of the disclosure, a coffee machine is provided, including:

a housing, wherein the housing is provided with a first mounting cavity, a side portion of the first mounting cavity is provided with a first opening, and the first opening is opened or closed by a detachable cover plate;

a support provided with a second mounting cavity, wherein the support is detachably mounted in the first mounting cavity, and the second mounting cavity is provided with a second opening;

a body, wherein the body is detachably mounted in the second mounting cavity, a brewing cavity is provided in the body, a water inlet and a water outlet are respectively formed in two ends of the brewing cavity, and a feeding port for coffee powder to enter is provided in a side portion of the brewing cavity; and the body is capable of entering or exiting from the first opening and the second opening;

a water-inlet sealing plate assembly, including a first sealing plate and a first power source, wherein the first sealing plate is movably mounted in the body, the first sealing plate is configured for opening and closing the water inlet, the first power source is mounted on the support, and the first power source is configured for driving the first sealing plate to act; and

a water-outlet sealing plate assembly mounted on the support, wherein an output end of the water-outlet sealing plate assembly is configured for sliding in the brewing cavity, and the water-outlet sealing plate assembly is provided with a water outlet channel.

Preferably, the water-inlet sealing plate assembly further includes a driving plate and an intermediate plate, wherein one end of the driving plate is rotatably mounted in the body through a first rotating shaft, the other end of the driving plate is hinged with one end of the intermediate plate, and the other end of the intermediate plate is hinged with the first sealing plate through a second rotating shaft, an inner side wall of the body is provided with a first guide slot and a second guide slot, an end portion of the second rotating shaft is located in the first guide slot, the first sealing plate is provided with a guide post, and an end portion of the guide post is located in the second guide slot.

Preferably, the first power source includes a first motor and a reducer, one end of the first rotating shaft is provided with a connecting hole and extends out of the body, the first motor and the reducer are mounted on the support, the first motor is connected with an input end of the reducer, and an output end of the reducer is in transmission connection with the connecting hole; and the output end of the reducer is connected with an output shaft, the output shaft is rotatably mounted on the support, and the output shaft extends into the second mounting cavity.

Preferably, the water-inlet sealing plate assembly further includes a water inlet pipeline, the water inlet pipeline includes a first interface, a duct and a water inlet channel arranged in the first sealing plate, the first interface is arranged penetrating through a side wall of the body, and the first interface is communicated with the water inlet channel through the duct; and the support is provided with a second interface, and the second interface extends into the second mounting cavity.

Preferably, the water-outlet sealing plate assembly includes a second sealing plate and a second power source, the second sealing plate is slidably mounted on the support, the second power source is mounted on the support, and an output end of the second power source is in transmission connection with the second sealing plate; and the water outlet channel is arranged penetrating through the second sealing plate.

Preferably, a limit plate is rotatably arranged on the support, and the limit plate is configured for opening and closing the second opening.

Preferably, an upper portion of the housing is further provided with a mounting hole, a bottom portion of the mounting hole is provided with a circuit board, the circuit board is provided with a light source and a switch module, a key assembly and a transparent plate are further mounted in the mounting hole, the key assembly is located above the switch module, the transparent plate is of an annular shape, the transparent plate is arranged around the key assembly, and the transparent plate is located above the light source.

Preferably, the transparent plate is provided with a light incident surface and a light emergent surface, and light entering from the light incident surface is capable of reaching the light emergent surface after being reflected at least twice.

Preferably, a side wall of the housing is provided with a coffee outlet structure, the coffee outlet structure includes a transfer cavity with a hollow interior, an upper portion of the transfer cavity is provided with a water inlet, a lower portion of the transfer cavity is provided with a water outlet, the water inlet and the water outlet are staggered, at least one bulge is arranged in the transfer cavity at a position where the coffee flows through, the at least one bulge is provided with a sharp corner, and the water inlet is communicated with the water outlet channel.

Preferably, the side wall of the housing is provided with a guide rail, a lifting frame is arranged on the guide rail in a liftable way, the lifting frame is connected with and positioned with respect to the guide rail by a magnetic force, and the transfer cavity is arranged in the lifting frame.

Any of the above technical themes at least has the following beneficial effects: according to the foregoing technical themes, during assembly, the body, the water-inlet sealing plate assembly and the water-outlet sealing plate assembly may be mounted on the support first, and then the whole body is mounted into the first mounting cavity after assembly. Compared with directly mounting the body, the water-inlet sealing plate assembly and the water-outlet sealing plate assembly into the housing, the assembly process can be optimized (if the body, the water-inlet sealing plate assembly and the water-outlet sealing plate assembly are directly mounted in the housing, it will take a long time to work in the housing; however, the operation space in the housing is not large, resulting in low work efficiency). Moreover, the body can be independently moved out relative to the support, and the water-outlet sealing plate assembly and the first power source are located on the support, such that the body can be simplified in structure, and a size of the body can be reduced, which is convenient to disassemble and assemble the body.

### BRIEF DESCRIPTION OF THE DRAWINGS

The disclosure is further described hereinafter with reference to the drawings and the embodiments.

FIG. 1 is a schematic diagram of an embodiment of the disclosure;

FIG.2 is an exploded schematic diagram of FIG. 1;

FIG. 3 is a schematic diagram showing an embodiment of a support, a body, a water-inlet sealing plate assembly and a water-outlet sealing plate assembly in the disclosure.

FIG. 4 is a first exploded schematic diagram of FIG. 3;

FIG. 5 is a second exploded schematic diagram of FIG. 3;

FIG. 6 is a third exploded schematic diagram of FIG. 3;

FIG. 7 is a schematic diagram showing an embodiment of a key assembly and peripheral components in the disclosure;

FIG. 8 is a sectional view of FIG. 7;

FIG. 9 is an exploded schematic diagram of FIG. 7;

FIG. 10 is a sectional view showing an embodiment of a transparent plate;

FIG. 11 is a schematic diagram showing an embodiment of a transfer cavity in the disclosure;

FIG. 12 is a schematic diagram showing an embodiment of a coffee outlet structure in the disclosure;

FIG. 13 is a first exploded schematic diagram of FIG. 12; and

FIG. 14 is a second exploded schematic diagram of FIG. 13.

### DETAILED DESCRIPTION

The detailed embodiments of the disclosure will be described in detail, the preferred embodiments of the disclosure are shown in the drawings, the drawings are intended to supplement the description in the written portion of the specification with figures, so that people can intuitively and vividly understand each technical feature and the overall technical theme of the disclosure, but it shall not be understood as a limitation to the protection scope of the disclosure.

In the description of the present disclosure, it should be understood that, descriptions relating to orientation, for example, orientation or positional relationships indicated by “up”, “down”, “front”, “back”, “left”, “right”, etc. are based on the orientation or positional relationships shown in the accompanying drawings, and are to facilitate the description of the present disclosure and simplify the description only, rather than indicating or implying that the device or element referred to must have a specific orientation or be constructed and operated in a specific orientation, and therefore cannot be construed as limiting the present disclosure.

In the description of the present disclosure, the meaning of “several” is one or more, the meaning of “a plurality of” is two or more, “greater than”, “less than”, “more than”, etc. are to be understood to exclude the given figure, and “above”, “below”, “within”, etc. are understood to include the given figure. If “first” and “second”, etc. are referred to, it is only for the purpose of distinguishing technical features, and shall not be understood as indicating or implying relative importance or implying the number of the indicated technical features or implying the sequence of the indicated technical features.

In the description of the present disclosure, unless otherwise explicitly defined, the words such as “set”, “install”, and “connect” should be understood in a broad sense, and those of ordinary skills in the art can determine the specific meanings of the above words in the present disclosure in a rational way in combination with the specific contents of the technical themes.

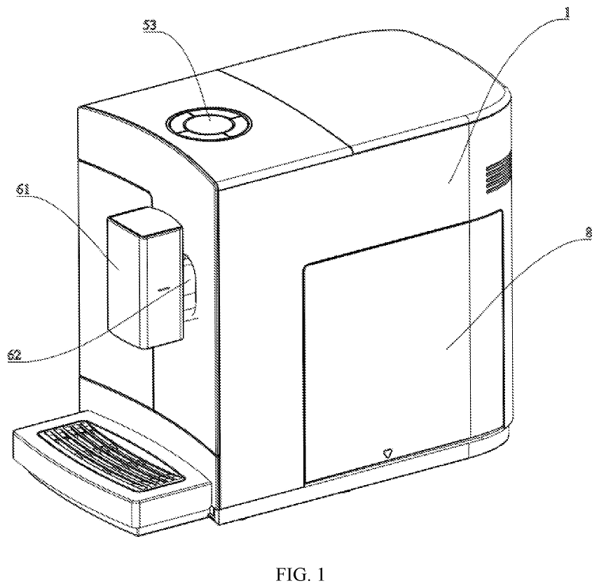

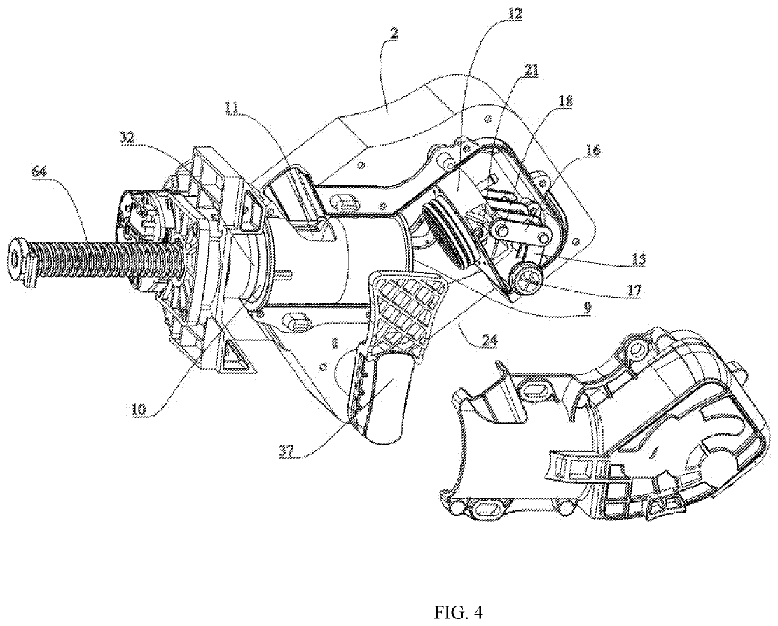

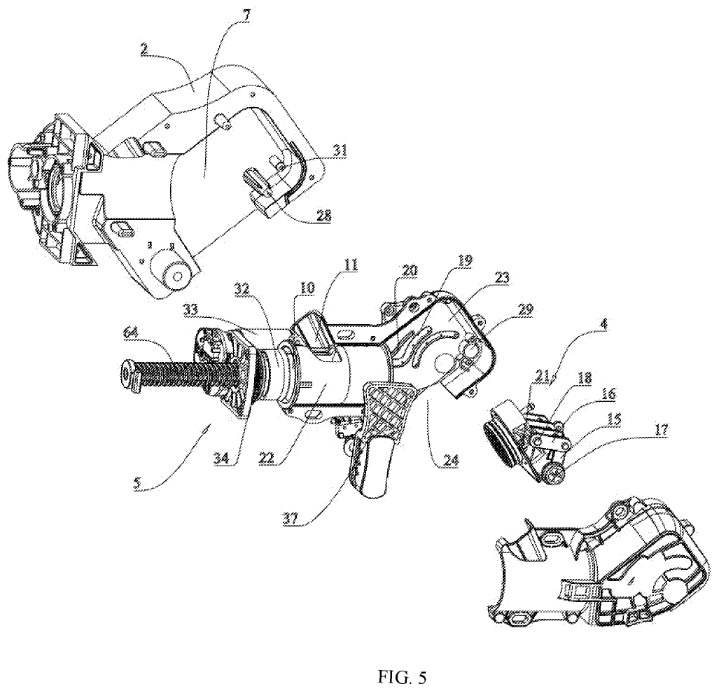

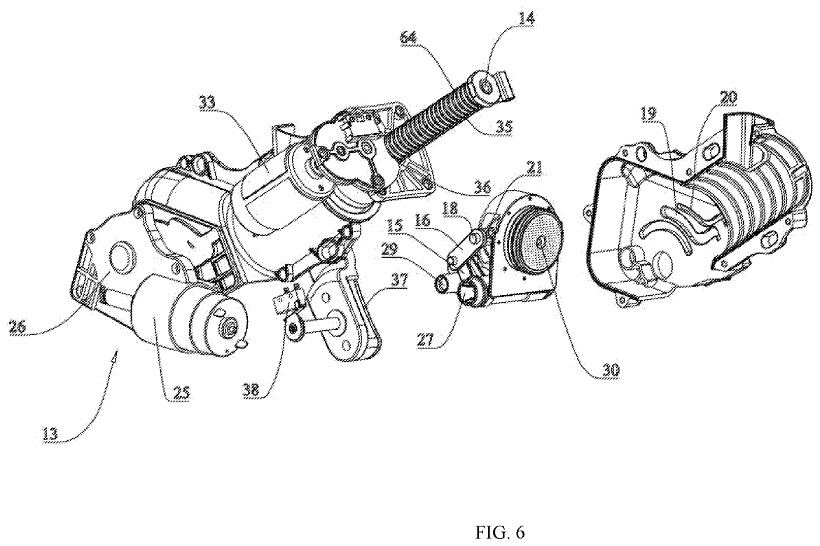

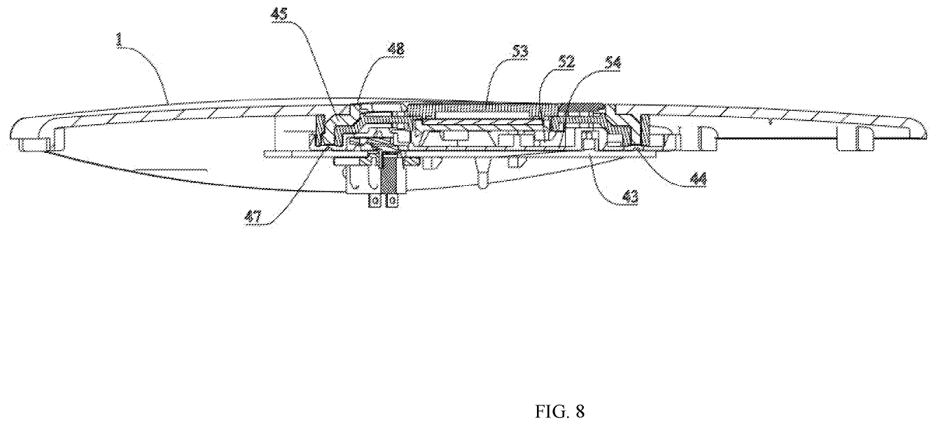

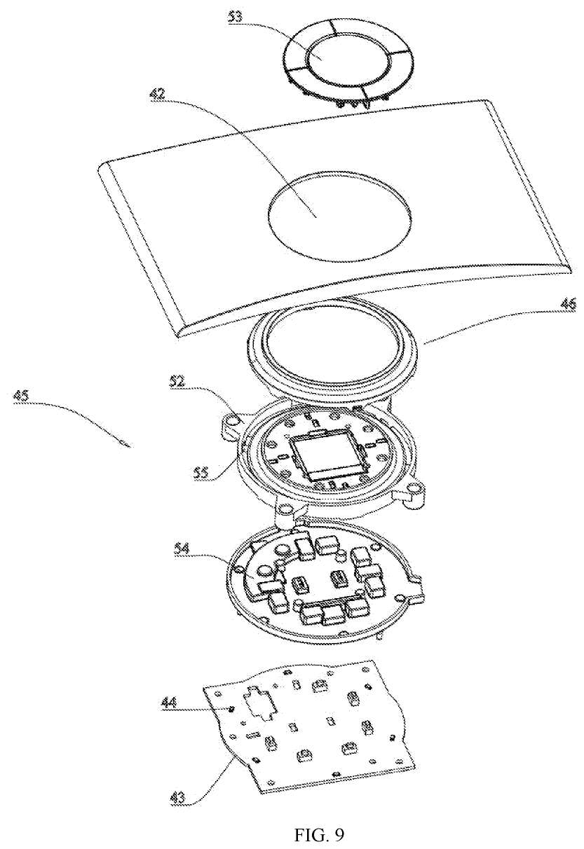

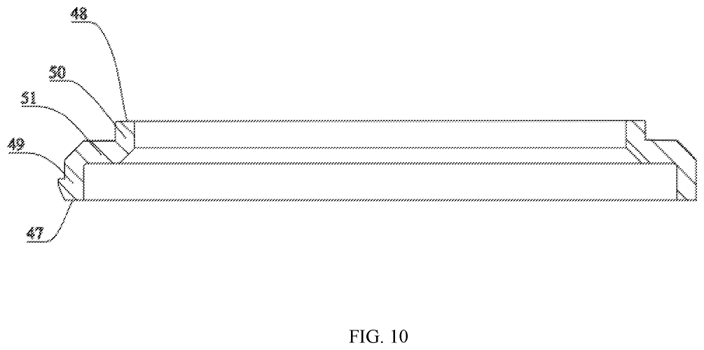

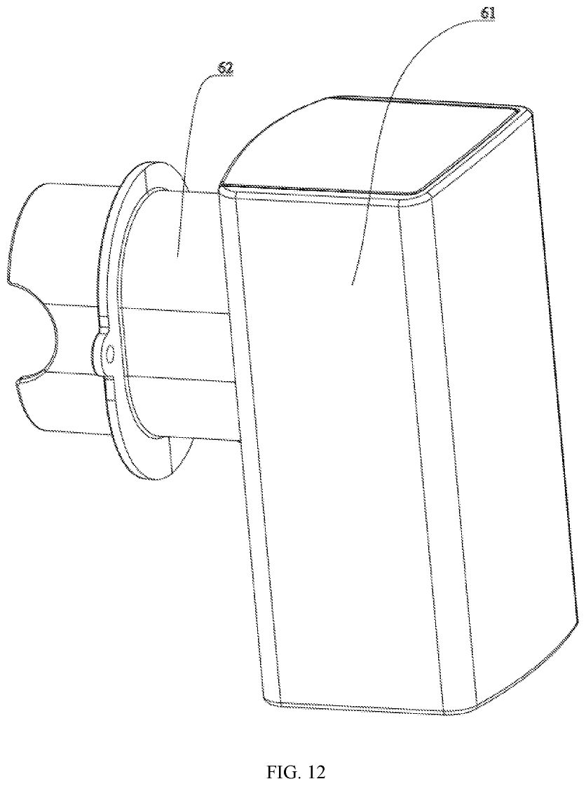

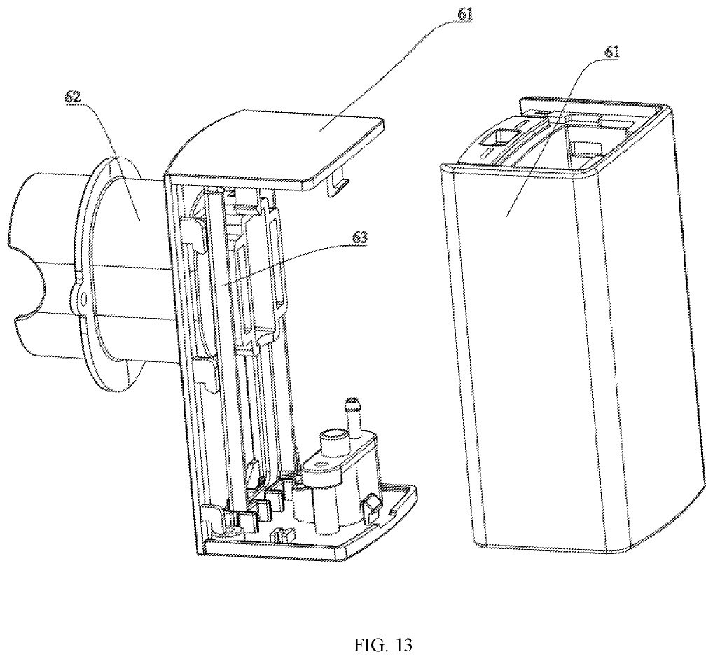

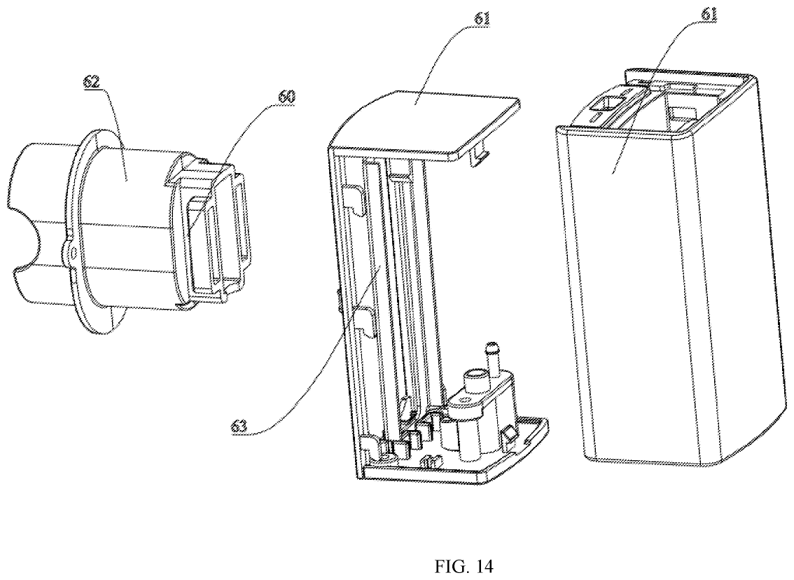

Referring to FIG. 1 to FIG. 14, a coffee machine includes a housing 1, a support 2, a body 3, a water-inlet sealing plate assembly 4 and a water-outlet sealing plate assembly 5. The housing 1 is provided with a first mounting cavity 6, a side portion of the first mounting cavity 6 is provided with a first opening, and the first opening is opened or closed by a detachable cover plate 8. The support 2 is provided with a second mounting cavity, the support 2 is detachably mounted in the first mounting cavity 6, and the second mounting cavity is provided with a second opening. The body 3 is detachably mounted on the mounting cavity 7, a brewing cavity is provided in the body 3, a water inlet 9 and a water outlet 10 are respectively formed in two ends of the brewing cavity, and a feeding port 11 for coffee powder to enter is provided in a side portion of the brewing cavity. The body 3 is capable of entering or exiting from the first opening and the second opening. The water-inlet sealing plate assembly 4 includes a first sealing plate 12, a water inlet pipeline and a first power source 13. The first sealing plate 12 is movably mounted in the body 3, the first sealing plate 12 is configured for opening and closing the water inlet 9, the first power source 13 is mounted on the support 2, and the first power source 13 is configured for driving the first sealing plate 12 to act. The water-outlet sealing plate assembly 5 is mounted on the support 2, an output end of the water-outlet sealing plate assembly 5 is configured for sliding in the brewing cavity, and the water-outlet sealing plate assembly 5 is provided with a water outlet channel 14.

The specific operation principle of the above embodiment is as follows. In an initial state, the first sealing plate 12 seals the water inlet 9, the coffee powder enters from the feeding port 11, then the output end of the water-outlet sealing plate assembly 5 moves towards inside of the brewing cavity, and cooperates with the first sealing plate 12 to form a closed cavity body in the brewing cavity. Then, high-temperature water is injected through the water inlet pipeline to brew the coffee powder. After brewing, the output end of the water-outlet sealing plate assembly 5 continues to slide towards inside of the brewing cavity, and the brewed coffee is extruded from the water outlet channel 14. According to the foregoing embodiment, during assembly, the body 3, the water-inlet sealing plate assembly 4 and the water-outlet sealing plate assembly 5 may be mounted on the support 2 first, and then the whole body is mounted into the first mounting cavity 6 after assembly. Compared with directly mounting the body 3, the water-inlet sealing plate assembly 4 and the water-outlet sealing plate assembly 5 into the housing 1, the assembly process can be optimized (if the body 3, the water-inlet sealing plate assembly 4 and the water-outlet sealing plate assembly 5 are directly mounted in the housing 1, it will take a long time to work in the housing 1; however, the operation space in the housing 1 is not large, resulting in low work efficiency). Moreover, the body 3 can be independently moved out relative to the support 2, and the water-outlet sealing plate assembly 5 and the first power source 13 are located on the support 2, such that the body 3 can be simplified in structure, and a size of the body 3 can be reduced, which is convenient to disassemble and assemble the body 3.

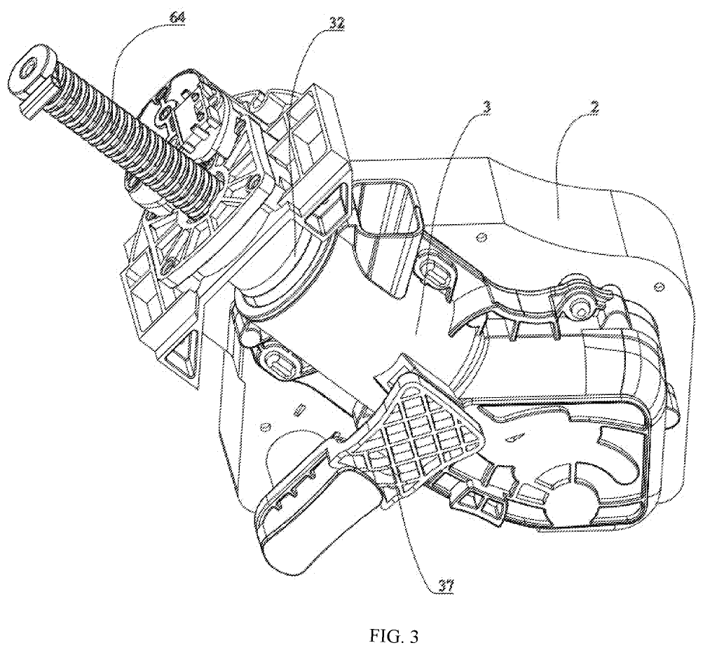

As shown in FIG. 3 to FIG. 6, in some embodiments, the water-inlet sealing plate assembly 4 further includes a driving plate 15 and an intermediate plate 16, one end of the driving plate 15 is rotatably mounted in the body 3 through a first rotating shaft 17, the other end of the driving plate 15 is hinged with one end of the intermediate plate 16, the other end of the intermediate plate 16 is hinged with the first sealing plate 102 through a second rotating shaft 18, an inner side wall of the body 3 is provided with a first guide slot 19 and a second guide slot 20, an end portion of the second rotating shaft 18 is located in the first guide slot 19, the first sealing plate 12 is provided with a guide post 21, an end portion of the guide post 21 is located in the second guide slot 20, and the first power source 13 is configured for driving the driving plate 15 to act. The driving plate 15, the intermediate plate 16 and the first sealing plate 12 are all located in the body 3, which may be combined with the first guide slot 19 and the second guide slot 20 to limit a movement track of the first sealing plate 12. The arrangement of the driving plate 15 and the intermediate plate 16 can amplify the power output from the first power source 13, so as to provide enough power for the first sealing plate 12. The water-inlet sealing plate assembly 4 above has a simple and ingenious structure, occupies a small volume, is beneficial to being separated from the first power source 13, and works stably and reliably.

As shown in FIG. 3 to FIG. 6, in some embodiments, in order to facilitate discharging coffee grounds, the body 3 includes an inclined section 22 and a horizontal section 23, the brewing cavity is located in the inclined section 22, the horizontal section 23 is butted with the water inlet 9 at a position below which a discharging hole 24 is arranged, and the driving plate 15 and the intermediate plate 16 are located at an end portion of the horizontal section 23 far away from the discharging hole 24. After the coffee is brewed, coffee grounds are generally attached to the first sealing plate 12, so that the coffee grounds may automatically be discharged from the brewing cavity, then leave the body 3 through the discharging hole 24 and then enter a trash when the water inlet 9 is opened by the first sealing plate 12. The trash is located in the first mounting cavity 6 and below the discharging hole 24. After the trash collects enough coffee grounds, the trash can be removed to pour the coffee grounds into a garbage can and then put back the trash in place. The embodiment of the body 3 above has a reasonable layout, which is beneficial to discharging coffee grounds and simplifies the overall structure.

As shown in FIG. 3 to FIG. 6, in some embodiments, the movement track of the first sealing plate 12 may be designed according to shapes of the first guide slot 19 and the second guide slot 20. After the coffee is brewed, the coffee grounds need to be discharged. In order to discharge the coffee grounds smoothly, the first sealing plate 12 needs to be rotated to face the ground. To this end, in this embodiment, the following design is made: the first guide slot 19 includes a first section and a second section which are connected with each other, the first section is parallel to a center line of the brewing cavity, and an included angle between the second section and the first section is set at 90 degrees to 135 degrees; the second guide slot 20 includes a third section and a fourth section which are connected with each other, the third section is parallel to the center line of the brewing cavity, and an included angle between the third section and the fourth section is set at 90 degrees to 135 degrees. Under the limitation of the first guide slot 19 and the second guide slot 20, the first sealing plate 12 is close to the brewing cavity in a state perpendicular to the center line of the brewing cavity. After the first sealing plate 12 is completely opened, the first sealing plate 12 inclines or vertically faces downwards, so that the coffee grounds on the first sealing plate 12 can be discharged. The design of the first guide slot 19 and the second guide slot 20 can realize that the first sealing plate 12 runs according to a set track, which is very convenient, is simpler in comparison to designing the movement track of the first sealing plate 12 by purely using a connecting rod structure, saves parts and saves the internal space.

As shown in FIG. 3 to FIG. 6, in some embodiments, the first power source 13 includes a first motor 25 and a reducer 26, one end of the first rotating shaft 17 is provided with a connecting hole 27 and extends out of the body 3, the first motor 25 and the reducer 26 are mounted on the support 2, the first motor 25 is connected with an input end of the reducer 26, and an output end of the reducer 26 is in transmission connection with the connecting hole 27. The reducer 26 may use a worm gear or gear box to reduce the speed. The output end of the reducer 26 is connected with an output shaft 28, the output shaft 28 is rotatably mounted on the support 2, and the output shaft 28 extends into the second mounting cavity 7. In this way, during the process of mounting the body 3 into the mounting cavity 7, the output shaft 28 is synchronously inserted into the connecting hole 27, an inner side wall of the connecting hole 27 is provided with a bulge, and an outer side wall of the output shaft 28 is provided with a recess matched with the bulge. By means of the bulge and the recess, a transmission connection is formed. From the above, it can be seen that the transmission connection between the first power source 13 and the first sealing plate 12 is very convenient, and the first power source 13 arranged on the support 2 does not cause any adverse influence on the driving of the first sealing plate 12. The structure is very ingenious and practical.

As shown in FIG. 3 to FIG. 6, in some embodiments, the water inlet pipeline includes a first interface 29, a duct and a water inlet channel 30 arranged in the first sealing plate 12, the first interface 29 is arranged penetrating through a side wall of the body 3, and the first interface 29 is communicated with the water inlet channel 30 through the duct. The support 2 is provided with a second interface 31, and the second interface 31 extends into the second mounting cavity 7. The first interface 29 and the second interface 31 are of a plug-in connection structure, and the connection between the first interface 29 and the second interface 31 may be completed synchronously in the process of mounting the body 3 into the second mounting cavity 7, which is very convenient. The duct is located in the body 3, that is, the duct can't be observed outside the body 3, so that the problem of duct layout disorder does not exist, and the possibility of duct winding or scraping is reduced.

As shown in FIG. 3 to FIG. 6, in some embodiments, the water-outlet sealing plate assembly 5 includes a second sealing plate 32 and a second power source 33, the second sealing plate 32 is slidably mounted on the support 2, the second power source 33 is mounted on the support 2, and an output end of the second power source 33 is in transmission connection with the second sealing plate 32; and the water outlet channel 14 is arranged penetrating through the second sealing plate 32. The second power source 33 is a second motor, the support 2 is rotatably provided with a gear 34, and the gear 34 is provided with a threaded hole; one side of the second sealing plate 32 is fixedly connected with a screw 64, the screw 64 is in threaded connection with the threaded hole, and an output end of the second motor is in transmission connection with the gear. A side wall of the screw 64 is provided with a third guide slot 35, and the support 2 is provided with a limiting block 36. The limiting block 36 is inserted into the third guide slot 35, so as to prevent the screw 64 rotating relative to the support 2, so that the screw 64 can only slide relative to the support 2. The action principle of the water-outlet sealing plate assembly 5 in the above embodiment is as follows: the second motor works, and the second motor drives the gear to rotate through a reduction gear set, and the gear cooperates with the screw 64. As the screw 64 cannot rotate, the screw 64 can only slide relative to the support 2, and then drives the second sealing plate 32 to slide in the brewing cavity. Certainly, it may be understood by those of ordinary skills in the art that the second power source 33 may also be implemented in other ways, such as using an air cylinder or oil cylinder or linear motor.

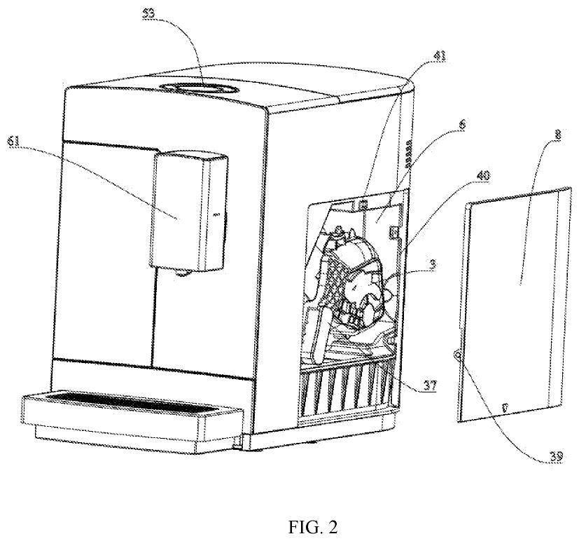

As shown in FIG. 2 to FIG. 6, in some embodiments, a limit plate 37 is rotatably arranged on the support 2, and the limit plate 37 is configured for opening and closing the second opening. The support 2 is also provided with a microswitch 38, and the microswitch 38 is configured to detect a state of the limit plate 37. When the limit plate 37 is in the position of opening the second opening, the coffee machine cannot work, and only when the limit plate 37 is in the position of closing the second opening, the coffee machine can work normally. By arranging the limit plate 37, the body 3 can be prevented from accidentally sliding out, thus ensuring the normal operation of the coffee machine.

As shown in FIG. 2, in some embodiments, a third rotating shaft 39 is arranged at a lower middle portion of the cover plate 8, and a sunken platform 40 is arranged at the opening. The sunken platform 40 is provided with an outward positioning slot 41. The third rotating shaft 39 is matched with the positioning slot 41, and the sunken platform 40 located at a lower portion of the positioning slot 41 is recessed towards inside of the housing 1 to provide space for a lower end of the cover plate 8 to rotate towards inside of the housing 1. An upper end of the cover plate 8 is connected with the sunken platform 40 by a magnetic force. In some embodiments, the upper end of the cover plate 8 is provided with a magnet, and the sunken platform 40 is provided with a patch corresponding to the magnet. In order to achieve a more stable connection, the sunken platform 40 is provided with a clamping hole and the upper end of the cover plate 8 is provided with a clamping hook. When the cover plate 8 needs to be disassembled, a lower portion of the cover plate 8 (located below the third rotating shaft 39) is pressed by hand, and the cover plate 8 can rotate about the third rotating shaft 39, so that the clamping hook is separated from the clamping hole, and the upper end of the cover plate 8 is separated from the sunken platform 40. In this case, the upper end of the cover plate 8 may be grabbed to move out the cover plate 8 as a whole, so that the body 3 can be taken and placed. The structure is very simple and ingenious.

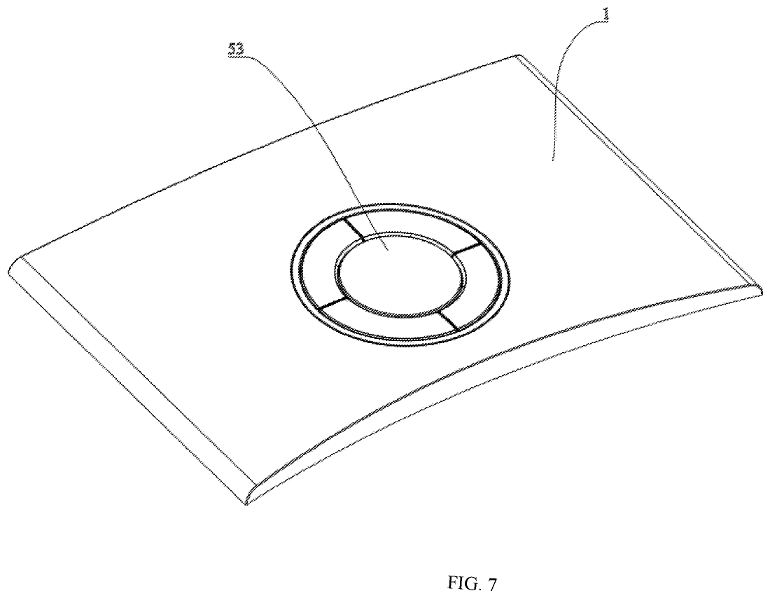

As shown in FIG. 7 to FIG. 10, in some embodiments, an upper portion of the housing 1 is further provided with a mounting hole 42, a bottom portion of the mounting hole 42 is provided with a circuit board 43, the circuit board 43 is provided with a light source 44 and a switch module, a key assembly 45 and a transparent plate 46 are further mounted in the mounting hole 42, the key assembly 45 is located above the switch module, the transparent plate 46 is of an annular shape, the transparent plate 46 is arranged around the key assembly 45, and the transparent plate 46 is located above the light source 44. In the above embodiment, the light source 44 is arranged on the circuit board 43, and the light emitted by the light source 44 is guided to the surrounding key assembly 45 by the transparent plate 46, so that the key assembly 45 is illuminated. Even if the coffee machine is in a dark environment, a user can still clearly observe the key assembly 45, thus reducing wrong operations. The disclosure has simple and practical structure and remarkable effects.

As shown in FIG. 7 to FIG. 10, in some embodiments, the transparent plate 46 is provided with a light incident surface 47 and a light emergent surface 48, and light entering from the light incident surface 47 is capable of reaching the light emergent surface 48 after being reflected at least twice. The main object of the light source 44 is to illuminate the periphery of the key assembly 45, so the power requirement of the light source 44 is low. Therefore, only a small number of light sources 44 are needed to achieve this object. The small number of light sources 44 will inevitably lead to the problem of concentrated light. In this embodiment, the light emitted by the light source 44 is reflected at least twice before being emitted, so that the light emitted by the light emergent surface 48 is more uniform, soft and not dazzling, giving people a very comfortable feeling. Certainly, it may be understood by those of ordinary skills in the art that the number of reflections between the light entering from the light incident surface 47 and the light emergent surface 48 may be adjusted according to the actual situation. If the power of the light source 44 is high, three reflections or four reflections may be set.

As shown in FIG. 7 to FIG. 10, in some embodiments, the transparent plate 46 includes a light incident section 49, a light emergent section 50 and an intermediate section 51. The light incident section 49, the light emergent section 50 and the intermediate section 51 are all of an annular shape, a diameter of the light incident section 49 is larger than that of the light emergent section 50, the light incident surface 47 is located at one end of the light incident section 49, the other end of the light incident section 49 is connected with one end of the light emergent section 50 through the intermediate section 51, the light emergent surface 48 is located at the other end of the light emergent section 50, a first chamfer is arranged outside a corner formed at a junction of the light incident section 49 and the intermediate section 51, and a second chamfer is arranged outside a corner formed at a junction of the light emergent section 50 and the intermediate section 51. In the above embodiment, the light emitted by the light source 44 enters from the light incident surface 47, is reflected at the first chamfer into the intermediate section 51, and then is reflected at the second chamfer into the light emergent section 50, and then is emitted from the light emergent surface 48. The transparent plate 46 with the above structure is easy to process, convenient to assemble, and low in cost. A shape of the transparent plate 46 may be designed according to a shape of the key assembly 45. If the key assembly 45 is of a square shape, the transparent plate 46 may be arranged in a square ring shape.

As shown in FIG. 7 to FIG. 10, in some embodiments, the key assembly 45 includes a supporting piece 52, an upper plate of the housing 1, and a key body 53. A protective layer is arranged between the supporting piece and the circuit board. The protective layer 54 covers the circuit board 43, and the supporting piece 52 is mounted on the circuit board 43. The supporting piece 52 is provided with an annular mounting slot corresponding to the transparent plate 46, and the key body 53 is mounted on the supporting piece 52 in a liftable way. The upper plate covers the intermediate section 51, and a diameter of the mounting hole 42 is adapted with an outer diameter of the light emergent section 50. In the above embodiment, the upper plate and the supporting piece 52 can fix the transparent plate 46, and meanwhile, can shield the side surfaces of the transparent plate 46 except the light incident surface 47 and the light emergent surface 48, so as to prevent the light from leaking out. Certainly, it may be understood by those of ordinary skills in the art that other ways may also be used to prevent the light from leaking out. For example, the side surfaces of the transparent plate 46 except the light incident surface 47 and the light emergent surface 48 may be coated with opaque paint to prevent the light from leaking out.

As shown in FIG. 7 to FIG. 10, in some embodiments, in order to allow the light emitted by the light source 44 to enter the light incident surface 47, the supporting piece 52 is provided with an avoidance hole 55 corresponding to the light source 44. Alternatively, the supporting piece 52 is arranged in a transparent shape corresponding to the light source 44, or, the whole supporting piece 52 is arranged in a transparent shape, which is beneficial to one-time processing and molding.

The protective layer 54 can prevent losses of the circuit board 43 caused by the key body 53. In order to prevent light attenuation from being too serious, the protective layer 54 is set in a transparent shape, which is beneficial to one-time processing and molding. Certainly, it may be understood by those of ordinary skills in the art that the protective layer 54 only needs to be set in a transparent shape corresponding to the light source 44.

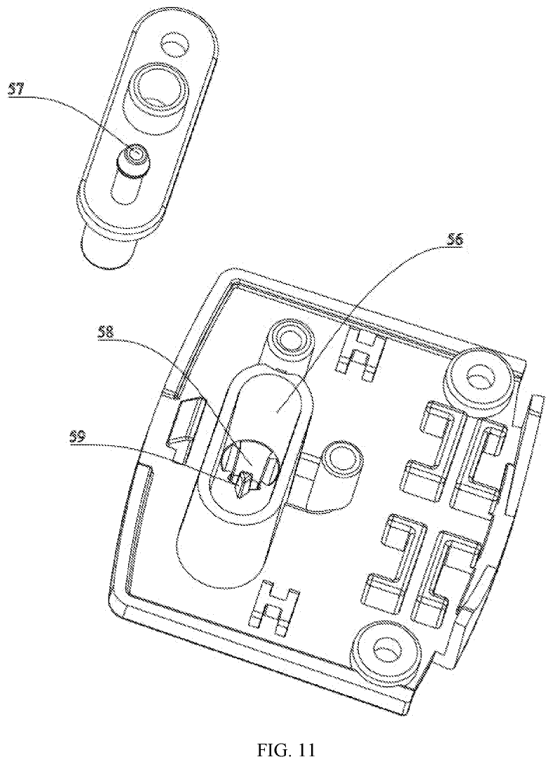

As shown in FIG. 11 to FIG. 14, in some embodiments, a side wall of the housing 1 is provided with a coffee outlet structure, the coffee outlet structure includes a transfer cavity 56, an interior of the transfer cavity 56 is hollow, an upper portion of the transfer cavity 56 is provided with a coffee inlet 57, a lower portion of the transfer cavity is provided with a coffee outlet 58, the coffee inlet 57 and the coffee outlet 58 are staggered, at least one bulge 59 is arranged in the transfer cavity 56 at a position where the coffee flows through, the bulge 59 is provided with a sharp corner, and the coffee inlet 57 is communicated with the water outlet channel 14. Brewed coffee enters the transfer cavity 56 from the water outlet channel 14, flows down to a bottom portion of the transfer cavity 56 under the action of gravity, and then flows along the bottom portion toward the coffee outlet 58, which can provide enough space for the arrangement of the bulge 59. The bulge 59 is located on a path at the bottom portion of the transfer cavity 56 where the coffee flows through, and the bulge 59 is in the shape of a triangular prism. The bulge 59 may also be provided in the shape of a triangular pyramid or a cuboid, and the like. In addition, in order to achieve a better bubble-piercing effect, it may be considered that four evenly distributed bulges 59 are also arranged on an inner wall of the coffee outlet 58, and the bulges 59 are in the shape of triangular prism; or, the bulge 59 is arranged on an inner side wall of the coffee inlet 57; the bulge 59 located on the path at the bottom portion of the transfer cavity 56 where the coffee flows through is close to the coffee outlet 58, the bulges 59 on the inner wall of the coffee outlet 58 are located at two sides of the bulge 59 located on the path at the bottom portion of the transfer cavity 56 where the coffee flows through, so that the coffee can be diverted and then flow through the bulge 59 on the coffee outlet 58, thereby improving the bubble-piercing effect.

Moreover, it may be understood by those of ordinary skills in the art that the bulge 59 located at the bottom portion of the transfer cavity 56, the bulge 59 on the inner side wall of the coffee inlet 57 and the bulge 59 on the inner side wall of the coffee outlet 58 may be independently arranged without interfering with each other, and may be arranged at only one position or at the three positions at the same time.

Moreover, it may be understood by those of ordinary skills in the art that the shape of the transfer cavity 56 is not limited to the above shapes, and may be any shape, such as a cuboid, and the like. The coffee inlet 57 and the coffee outlet 58 may also be arranged on the same line. In this case, it is only necessary to set the bulges 59 in the coffee inlet 57 and the coffee outlet 58.

As shown in FIG. 11 to FIG. 14, in some embodiments, the side wall of the housing 1 is provided with a guide rail 60, a lifting frame 61 is arranged on the guide rail 60 in a liftable way, the lifting frame 61 and the guide rail 60 are connected and positioned by a magnetic force, and the transfer cavity 56 is arranged in the lifting frame 61. The magnetic force between the lifting frame 61 and the guide rail 60 can ensure that the two are kept in a stable state without external force. When a height of the lifting frame 61 needs to be adjusted, the lifting frame 61 may be moved up and down by a manual force. The lifting frame 61 may move up and down to adjust the height of the coffee outlet so as to be suitable for cups with different heights.

A mounting rod 62 is protruded from the side wall of the housing 1, and the guide rail 60 includes two fourth guide slots which are vertically arranged, and the two fourth guide slots are respectively arranged on two vertical outer side walls of the mounting rod 62. The mounting rod 62 is made of an iron material, and the lifting frame is provided with a vertical rod 63. The vertical rod 63 is magnetic and the vertical rod 63 can slide in the fourth guide slot. The vertical rod 63 may be made of a magnetic material, or a magnet may be mounted on the vertical rod 63 to realize magnetism of the vertical rod 63. The vertical rod 63 is relatively closely matched with the fourth guide slot, which can reduce unnecessary swinging under the condition of ensuring normal lifting.

The embodiments of the disclosure are described in detail with reference to the drawings above, but the disclosure is not limited to the above embodiments, and various changes may also be made within the knowledge scope of those of ordinary skills in the art without departing from the purpose of the disclosure.

1. A coffee machine, comprising:
a housing, wherein the housing is provided with a first mounting cavity, a side portion of the first mounting cavity is provided with a first opening, and the first opening is opened or closed by a detachable cover plate;
a support provided with a second mounting cavity, wherein the support is detachably mounted in the first mounting cavity, and the second mounting cavity is provided with a second opening;
a body, wherein the body is detachably mounted in the second mounting cavity, a brewing cavity is provided in the body, a water inlet and a water outlet are respectively formed in two ends of the brewing cavity, and a feeding port for coffee powder to enter is provided in a side portion of the brewing cavity; and the body is capable of entering or exiting from the first opening and the second opening;
a water-inlet sealing plate assembly, comprising a first sealing plate and a first power source, wherein the first sealing plate is movably mounted in the body, the first sealing plate is configured for opening and closing the water inlet, the first power source is mounted on the support, and the first power source is configured for driving the first sealing plate to act; and
a water-outlet sealing plate assembly mounted on the support, wherein an output end of the water-outlet sealing plate assembly is configured for sliding in the brewing cavity, and the water-outlet sealing plate assembly is provided with a water outlet channel.

2. The coffee machine according to claim 1, wherein the water-inlet sealing plate assembly further comprises a driving plate and an intermediate plate, one end of the driving plate is rotatably mounted in the body through a first rotating shaft, the other end of the driving plate is hinged with one end of the intermediate plate, and the other end of the intermediate plate is hinged with the first sealing plate through a second rotating shaft, an inner side wall of the body is provided with a first guide slot and a second guide slot, an end portion of the second rotating shaft is located in the first guide slot, the first sealing plate is provided with a guide post, and an end portion of the guide post is located in the second guide slot.

3. The coffee machine according to claim 2, wherein the first power source comprises a first motor and a reducer, one end of the first rotating shaft is provided with a connecting hole and extends out of the body, the first motor and the reducer are mounted on the support, the first motor is connected with an input end of the reducer, and an output end of the reducer is in transmission connection with the connecting hole; and the output end of the reducer is connected with an output shaft, the output shaft is rotatably mounted on the support, and the output shaft extends into the second mounting cavity.

4. The coffee machine according to claim 3, wherein the water-inlet sealing plate assembly further comprises a water inlet pipeline, the water inlet pipeline comprises a first interface, a duct and a water inlet channel arranged in the first sealing plate, the first interface is arranged penetrating through a side wall of the body, and the first interface is communicated with the water inlet channel through the duct; and the support is provided with a second interface, and the second interface extends into the second mounting cavity.

5. The coffee machine according to claim 1, wherein the water-outlet sealing plate assembly comprises a second sealing plate and a second power source, the second sealing plate is slidably mounted on the support, the second power source is mounted on the support, and an output end of the second power source is in transmission connection with the second sealing plate; and the water outlet channel is arranged penetrating through the second sealing plate.

6. The coffee machine according to claim 1, wherein a limit plate is rotatably arranged on the support, and the limit plate is configured for opening and closing the second opening.

7. The coffee machine according to claim 1, wherein an upper portion of the housing is further provided with a mounting hole, a bottom portion of the mounting hole is provided with a circuit board, the circuit board is provided with a light source and a switch module, a key assembly and a transparent plate are further mounted in the mounting hole, the key assembly is located above the switch module, the transparent plate is of an annular shape, the transparent plate is arranged around the key assembly, and the transparent plate is located above the light source.

8. The coffee machine according to claim 7, wherein the transparent plate is provided with a light incident surface and a light emergent surface, and light entering from the light incident surface is capable of reaching the light emergent surface after being reflected at least twice.

9. The coffee machine according to claim 1, wherein a side wall of the housing is provided with a coffee outlet structure, the coffee outlet structure comprises a transfer cavity with a hollow interior, an upper portion of the transfer cavity is provided with a water inlet, a lower portion of the transfer cavity is provided with a water outlet, the water inlet and the water outlet are staggered, at least one bulge is arranged in the transfer cavity at a position where coffee flows through, the at least one bulge is provided with a sharp corner, and the water inlet is communicated with the water outlet channel.

10. The coffee machine according to claim 9, wherein the side wall of the housing is provided with a guide rail, a lifting frame is arranged on the guide rail in a liftable way, the lifting frame is connected with and positioned with respect to the guide rail by a magnetic force, and the transfer cavity is arranged in the lifting frame.
